(19) United States
(12) Patent Application Publication
(10) Pub. No.: US 2015/0077697 A1
(43) Pub. Date: Mar. 19, 2015

(54) EYEWEAR WITH CUTAWAY FOR FACILITATING COMMUNICATION BETWEEN A USER'S FACE AND ONE OR MORE SENSORS

(71) Applicant: Marchon Eyewear, Inc., Melville, NY (US)

(72) Inventors: Claudio Gottardi, Pinebrook, NJ (US); Leslie Muller, Woodbury, NY (US)

(21) Appl. No.: 14/490,551

(22) Filed: Sep. 18, 2014

Related U.S. Application Data
(60) Provisional application No. 61/879,542, filed on Sep. 18, 2013.

(51) Int. Cl. G02C 11/00; G02C 5/00; G02C 7/02

(52) U.S. Cl. CPC G02C 11/10; G02C 7/02; G02C 5/001
USPC 351/111; 351/159.01

(57) ABSTRACT

Various embodiments comprise eyewear that includes a frame that is adapted to support a computing device having at least one sensor. In a particular embodiment, the eyewear defines an opening or cutaway in its frame or one or more of its lenses to allow an infrared sensor, or other sensor, associated with the computing device to monitor the movement of a user's face (e.g. one or more of the user's eyes) through the opening or cutaway. This may, for example, allow the sensor to be used to receive instructions from a user via pre-defined movements of a user's face. The sensor may also be used to detect when the user is wearing the eyewear.

### BACKGROUND

Wearable computing devices, such as Google Glass, are used by some to perform certain tasks such as taking pictures, tracking a user's movements, and performing various calculations. Currently, there is a need for improved methods for controlling, and otherwise interacting with, such computing devices.

### BRIEF DESCRIPTION OF THE DRAWINGS

Various embodiments of eyewear configured to support computing device(s) are described below. In the course of this description, reference will be made to the accompanying drawings, which are not necessarily drawn to scale, and wherein:

FIGS. 1-3 depict eyewear with a computing device according to a first embodiment;

FIGS. 4-6 depict eyewear with a computing device according to another embodiment;

FIGS. 7, 8, 9a, and 9b, depict eyewear with a computing device according to yet another embodiment;

FIGS. 10a and 10b depict eyewear with a computing device according to yet another embodiment (in these figures, the interior portion of an opening 480a is represented by hash lines);

FIGS. 11 and 12 depict eyewear with a computing device according to the embodiment shown in FIGS. 7, 8, 9a, and 9b;

FIG. 13 depicts exemplary system architecture for an example computing device.

### DETAILED DESCRIPTION OF VARIOUS EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As used in the specification and the claims, numerical ranges may be expressed as from “about” one particular value, and/or to “about” another particular value. It should be understood that, in such situations, the endpoints of each of the ranges are significant both in relation to the other endpoint, and independently of the other endpoint. It should also be understood that, when a range of numbers is recited, each unit between two particular end units within the range is also disclosed. For example, if a range of between 10 and 15 is disclosed, then 11, 12, 13, and 14 are also each disclosed.

As used in this specification, the term cutaway is used to refer to, for example, an opening that extends at least partially through at least a portion of a solid object, or a recess in a perimeter portion of a solid object.

### Overview

Various embodiments comprise eyewear that includes a frame that is adapted to support a computing device having at least one sensor. In a particular embodiment, the eyewear defines an opening (which may, for example, be a cutaway) in its frame or one or more of its lenses to allow an infrared sensor, or other sensor, associated with the computing device to monitor the movement of a user's face (e.g. one or more of the user's eyes) through the opening or cutaway. This may, for example, allow the sensor to be used to receive instructions from a user via pre-defined movements of a user's face (e.g., winking, twitching, or raising an eyebrow). The sensor may also be used to detect when the user is wearing the eyewear (e.g., by sensing, via the infrared sensor, whether the user's face is in close proximity to the eyewear and/or the sensor). The structure and function of eyewear and lenses according to various embodiments is described below.

### Eyewear

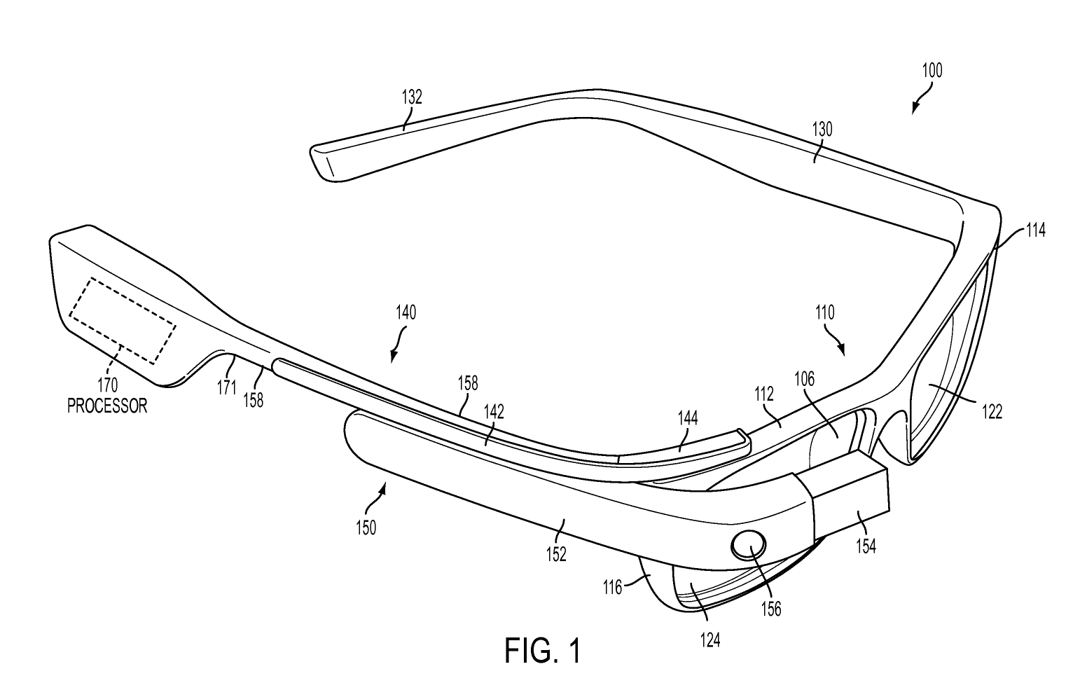

As shown in FIG. 1, eyewear 100, according to various embodiments, includes: (1) an eyeglass frame 110; (2) a first temple portion 130; (3) a second temple portion 140; and (4) one or more computing devices 150. These various components are discussed in more detail below.

### Eyeglass Frame

Eyewear, in various embodiments, includes any suitable eyeglass frame 110 configured to support one or more lenses 122, 124. In the embodiment shown in this figure, the eyeglass frame 110 has a first side 114 and a second side 116 and defines a top surface 112. In particular embodiments, the eyewear frame 110 is configured to support the first and second lenses 122, 124 about the full perimeter of the first and second lenses 122, 124. In other embodiments, the eyeglass frame 110 may be configured to support the first and second lenses about only a portion of each respective lens. In various embodiments, the eyeglass frame 110 is configured to support a number of lenses other than two lenses (e.g., a single lens, a plurality of lenses other than two, etc.). In particular embodiments, the lenses 122, 124 may include prescription lenses, sunglass lenses, or any other suitable type of lens (e.g., reading lenses, non-prescription lenses).

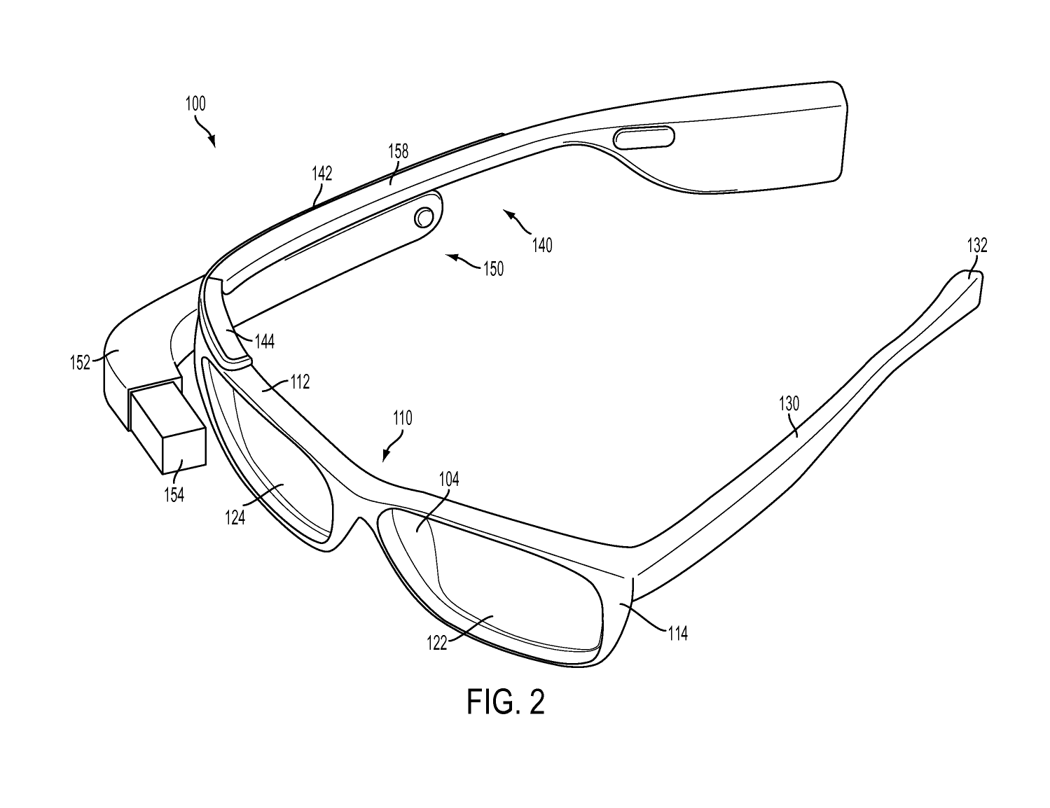

In the embodiment shown in FIGS. 1 and 2, the eyeglass frame 110 includes a first and second nose pad 104, 106, which may be configured to maintain the eyewear 100 adjacent the front of a wearer's face so that the lenses 122, 124 are positioned substantially in front of the wearer's eyes while the wearer is wearing the eyewear 100. In particular embodiments, the nose pads 104, 106 may comprise a material that is configured to be comfortable when worn by the wearer (e.g., rubber, etc.). In other embodiments, the nose pads 104, 106 may include any other suitable material (e.g., plastic, metal, etc.).

### First Temple Portion

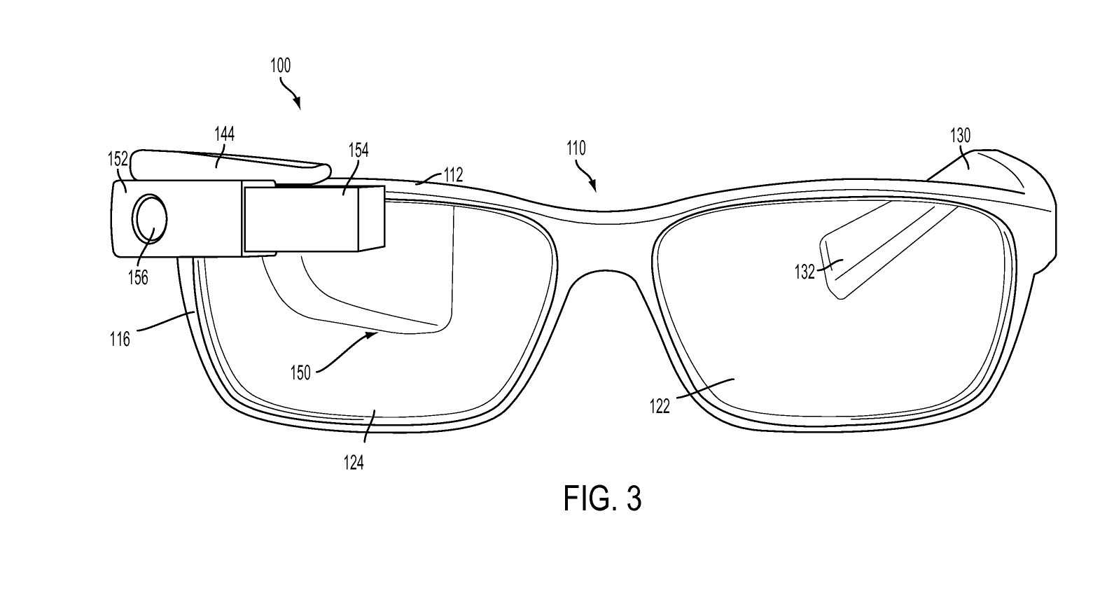

As shown in FIGS. 1-3, the first temple portion 130, according to various embodiments, extends substantially rearward from the eyeglass frame 110 adjacent a first side 114 of the eyeglass frame 110. As shown in these figures, the first temple portion 130 includes an earpiece 132 configured to be supported by a wearer's ear.

### Second Temple Portion

As shown in FIGS. 1-3, the second temple portion 140 extends substantially rearward from the eyeglass frame 110 adjacent a second side 116 of the eyeglass frame 110. In the embodiment shown in these figures, the second temple portion 140 includes a computing device support arm 142 that is coupled to the eyewear frame 110 by a computing device support arm mount 144. In particular embodiments, the computing device support arm mount 144 is disposed along at least a portion of the top surface 112 of the eyeglass frame 110 adjacent the eyewear frame second side 116. In various embodiments, the eyewear frame 110 and the computing device support arm mount 144 may form a substantially continuous, single piece of material (e.g., may be integrally formed). In other embodiments, the computing device support arm mount 144 and the eyewear frame 110 may include one or more pieces of material that are attached to the eyewear frame 110 in any suitable manner (e.g., via any suitable adhesive, screws or other suitable fastener(s)).

In particular embodiments, the computing device support arm mount 144 may extend at least substantially perpendicularly from the eyewear frame's top surface 112 so as to support the computing device support arm 142 above the eyewear frame's top surface 112. In other embodiments, the computing device support arm mount 144 may extend substantially upwardly from an upper portion of the eyewear frame 110 in any other suitable manner such that at least a portion of the second temple portion 140 (e.g., the computing device support arm 142) is above the eyewear frame's top surface 112.

In the embodiment shown in FIG. 1, the computing device support arm 142 is substantially parallel to the first temple portion 130, and the computer device support arm 142 is disposed in a position that is higher than the first temple portion 130. In particular embodiments, the computing device support arm 142 is configured to support one or more computing devices 150 (an exemplary computing device 150 is described more fully below). That is, the computer device support arm 142 may be sized, shaped, and positioned with respect to the eyewear frame 110 such that a display 154 associated with a supported computing device 150 is located in a suitable position for viewing by a wearer of the eyewear 100.

Referring once again to FIGS. 1-3, in particular embodiments, the computing device support arm 142 may be configured to enable a user to selectively attach and/or remove the computing device 150 substantially without the use of tools. In other embodiments, the computing device 150 may be attached adjacent (e.g., to) the computing device support arm 142 in a manner that may require tools to remove the computing device 150 from the computing device support arm 142. In other embodiments, the computing device 150 may be substantially permanently attached to the computing device support arm 142.

### Computing Device

In various embodiments, the computing device 150 comprises: (1) one or more processors 170; (2) a display support 152; (3) one or more displays 154; (4) one or more cameras 156; (5) a computing device mounting portion 158; and (6) one or more sensors 180. A discussion of an exemplary computing device 150 architecture can be found below.

### Display

In various embodiments, the display support 152 is configured to maintain the display 154 in a location suitable for viewing by the wearer of the eyewear 100 while the computing device 150 is supported by the computing device support arm 142. In the embodiment shown in FIGS. 1-3, the display 154 is positioned such that the display is in line with and spaced apart from an upper portion of the lens 122. In this configuration, the display 154 is disposed in a location that enables a wearer of the eyewear 100 to at least partially view the display 154 while wearing the eyewear 100. In the embodiment shown in FIGS. 1-3 and in other embodiments, the display 154 is positioned such that a wearer of the eyewear 100 may view the display 154 without causing substantial blockage of the user's sight and/or strain on the wearer's eyes (e.g., because the display 154 is disposed within the wearer's field of vision such that the display 154 is visible to the wearer without having to look up, down, left, right, etc.). In other embodiments, the display 154 is disposed sufficiently out of (e.g., in a location above) the wearer's field of vision such that the display 154 does not substantially interfere with the wearer's field of vision. In such embodiments, the wearer may need to look up (e.g., or in a direction in which the display is positioned relative to the wearer's field of vision) in order to at least partially view the display 154.

In other embodiments, such as embodiments in which the computing device support arm 142 is substantially aligned with the eyewear frame's top surface 112, the computing device 150 may be sized and shaped such that the display 154 is disposed in a position suitable for viewing by the user (e.g., the display 154 is in a position similar to the position that results when the computing device support arm 142 is offset from the top surface 112). The display support 152 may, for example, be at least partially curved to raise the display 154 to a suitable position, or have any other suitable configuration for achieving a suitable position of the display 154.

In particular embodiments, the one or more lenses 122, 124 may comprise at least a portion of the display 154. In other embodiments, the one or more lenses 122, 124 may comprise the entire display 154.

### Camera

In various embodiments, the computing device 150 includes one or more cameras 156. The one or more cameras 156 may be configured to enable the user of the eyewear 100 to capture one or more images (e.g., video images, still images, etc.), for example, using the computing device 150. In other embodiments where the display is in the direct line of sight of the user, the camera 156 may capture the image that the user would see if the display 154 were not present and display the image on the display 154. This may allow the user to view their surroundings without having to move the display out of their line of sight (e.g., the user's right eye views their surroundings on the display 154 while their left eye views the user's surroundings directly with the left eye itself).

### Sensors

As shown in FIG. 1, the computing device 150 may include at least one sensor 180. In the embodiment shown in this Figure, a sensor 180 is disposed adjacent the display 154 and is configured to detect movement of a heat source (e.g., a user's face) such as movement of portions of the user's face toward or away from the sensor 180. Such configurations enable the sensor 180 to substantially automatically detect various (e.g., predetermined) facial gestures such as, for example, winking, blinking, particular eye movements, the raising of an eyebrow, and/or any other suitable facial gestures. In a particular embodiment, the sensor 180 comprises an infrared sensor (IR sensor) that may, for example, be configured to detect infrared radiation emitted from a user of the eyewear's face in order to detect movement of a heat source (e.g., the user's face). In other embodiments, the sensor 180 may include any other suitable sensor for detecting facial gestures, such as, for example, a camera or other suitable sensor.

In various other embodiments, other types of suitable sensors may be used in place, or in addition to, the above-described sensor 180. Examples of suitable sensors may include, for example, any suitable proximity sensor, light sensor, microphone, motion sensor, odor sensor, electronic chemical sensor, and/or any other suitable sensor.

In particular embodiments, the computing device 150 is configured to perform one or more particular processes at least partially in response to detection, by the sensor 180, of one or more particular facial gestures. For example, in response to the sensor 180 sensing that a user winked or raised an eyebrow, the computing device 150 may be configured to take a photograph, for example, using a camera 156 associated with the computing device 150.

### Computing Device Mounting Portion

In various embodiments, the computing device mounting portion 158 is configured to cooperate with the computing device mounting arm 142 to maintain the computing device 150 adjacent the eyewear 100. In particular embodiments, the computing device mounting portion 158 may include any suitable attachment mechanism (e.g., such as an attachment mechanism that is configured to cooperate with a corresponding attachment mechanism of the computing device mounting arm 142). Suitable attachment mechanisms may include a tongue formed on one of the computing device mounting arm 142 and the computing device 150 and a groove formed in the other so that the groove receives the tongue thereby coupling the parts. In other embodiments, the computing device 150 may be coupled to the computing device mounting arm 142 by one or more suitable fasteners (e.g., screws, rivets, etc.).

Eyewear Frame with Cutaway

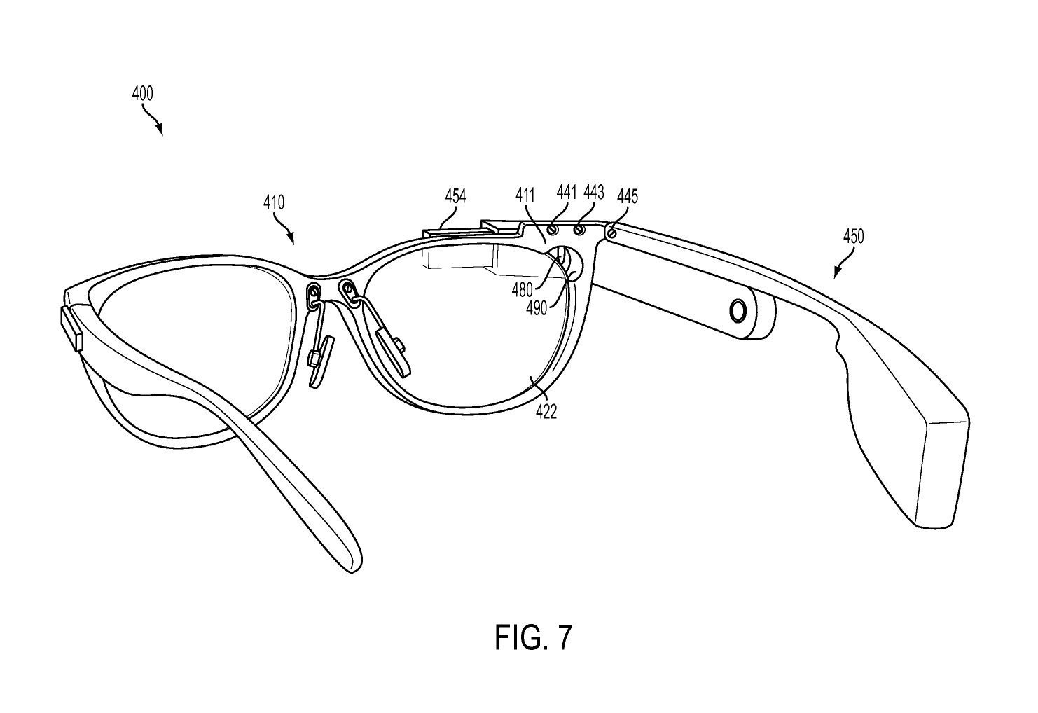

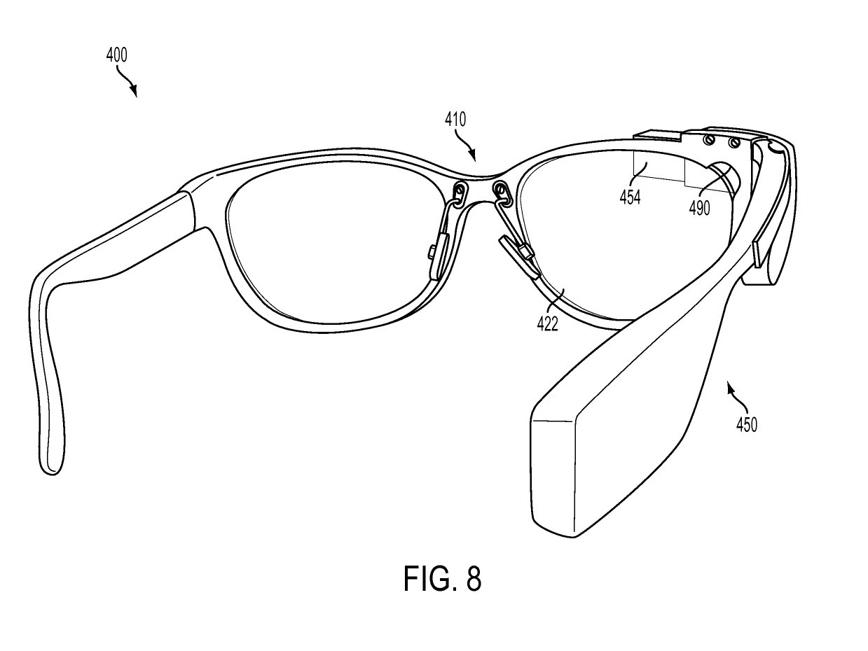

In the embodiment shown in FIGS. 7, 8, 9a, 9b, 11, and 12, exemplary eyewear 400 comprises similar components as the eyewear 100 described in FIG. 1, which will not be repeated herein for the purpose of brevity. However, it should be understood from reference to this disclosure that the various parts of the eyewear 400 may function similarly to those corresponding parts described with reference to, and shown in, FIG. 1. As such, only particular differences between the eyewear 400 and the eyewear 100 of FIG. 1 will be described in this section.

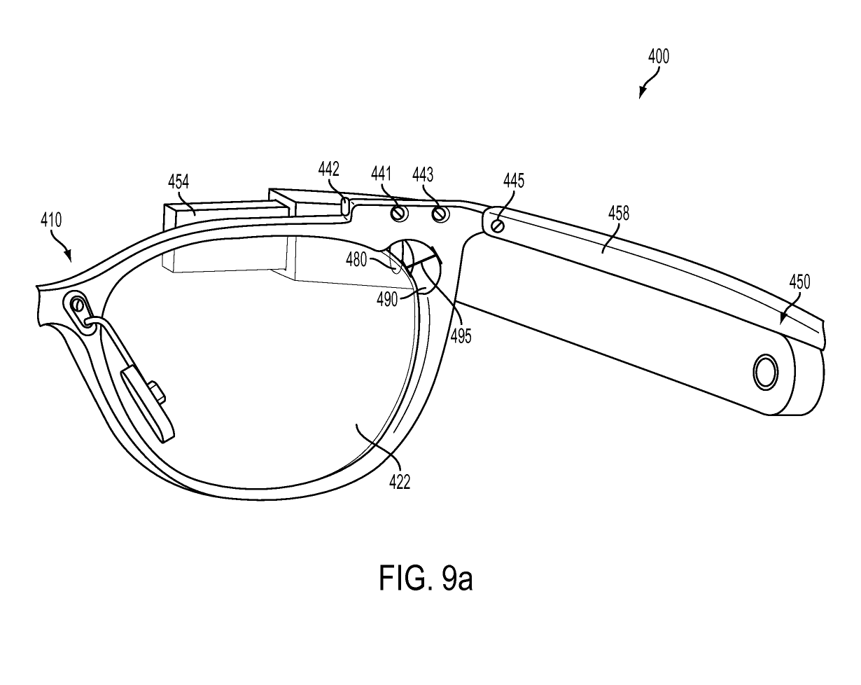

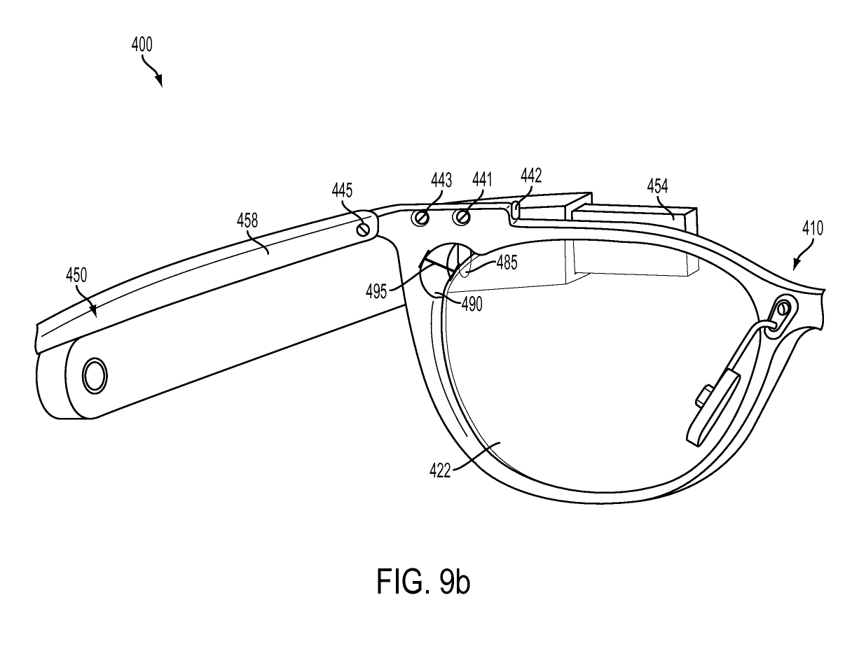

In various embodiments, the eyewear 400 comprises a first and a second screw (or other suitable fasteners), respectively, 441 and 443 for selectively coupling the computing device mounting arm 442 to the eyewear frame 410. The eyewear 400 also comprises a third screw 445 for selectively coupling the computing device mounting portion 458 (FIG. 9a) to the computing device mounting arm 442 (FIG. 9a).

Referring particularly to FIG. 7, the eyewear 400 may comprise a cutaway 490 defined by the eyewear frame 410 proximate an upper right corner of the frame. As may be understood by reference to the figure, the cutaway 490 may be substantially semi-circular (e.g., semi-circular) and formed adjacent an upper outside portion of the lens 422 so that the cutaway is substantially positioned between the sensor 480 and the face of the user when the eyewear 400 is worn by the user. Referring briefly to FIG. 9a, the cutaway 490 has a dimension 495 (e.g., a width and/or radius) of between about 1 millimeter and about 10 millimeters. In a particular embodiment, this dimension 495 is about 5 millimeters in length. As shown in FIG. 9a, the dimension 495 is the radius, and the cutaway 490 is substantially semi-circular. In other embodiments, the cutaway 490 may be of any other suitable shape (e.g., the cutaway may have a substantially uniform cross-section in the shape of, for example, any suitably sized polygon such as a rectangle or triangle). In particular embodiments, the cutaway 490 is sufficiently large to allow air, heat, and/or radiation to flow (e.g., substantially freely) through the cutaway.

In the embodiment shown in FIG. 7, the cutaway 490 has a substantially uniform cross-section (e.g., a profile of the cutaway 490 is substantially the same throughout the thickness of the eyewear frame). In other embodiments, the cutaway 490 has a first dimension adjacent a rear face 411 of the eyeglass frame 410 and a second dimension adjacent a front face (not pictured) of the eyeglass frame 410. For example, the cutaway 490 may be substantially conical so that a substantially circular opening of the cutaway 490 formed on the frame's rear face 411 is at least slightly larger than a substantially circular opening of the cutaway 490 formed on the frame's front face (not pictured). In some embodiments, the substantially conical configuration of the cutaway 490 may assist in at least partially directing airflow from the user's face toward the area in front of the frame 410 (e.g., toward at least a portion of the computing device 450 such as the sensor 480).

It should be understood that the cutaway 490 may be sized and positioned to enable the sensor 480 (e.g., IR sensor) to detect the movement of the user's face substantially without the eyeglass frame 410 or lens 422 interfering with heat or other radiation registration of the sensor 480 while the user is wearing the eyewear. The sensor 480, for example, may be configured to detect movement of the user's face at least in part by sensing differences in the level of radiated heat traveling between the user's face and the sensor 480. As may be understood from FIG. 7, the position and configuration of the cutaway 490 may enable substantially unimpeded air, heat and/or radiation flow between the user's face and the sensor 480. In other embodiments, such as embodiments without a cutaway 490, the lens 422, eyewear frame 410, or both may at least partially interfere with an ability of the sensor 480 to detect facial gestures of the user of the eyewear.

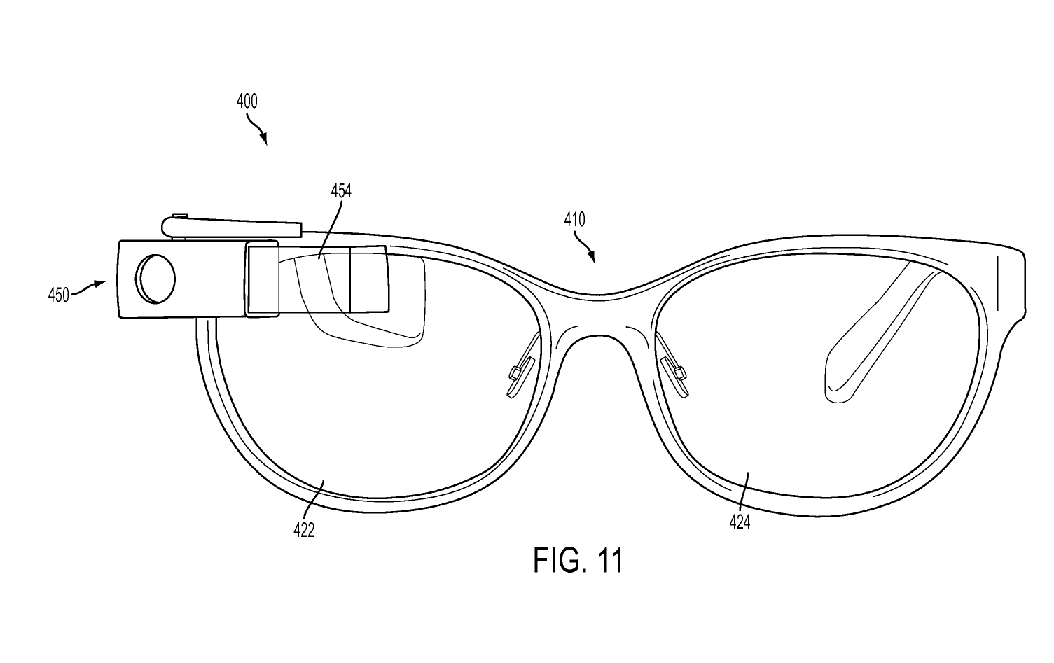

Referring to FIG. 11, it should be understood that the cutaway (not pictured) may be substantially visually obscured by the computing device 450 when the eyewear 400 is viewed from the front (e.g., may be sized and positioned such that a person looking at a user wearing the eyewear 400 may be unable to see the cutaway). In particular embodiments, the obstruction of the view of the cutaway (not pictured) may provide the benefit of an improved ability of the sensor (not pictured) to detect facial gestures of the user while not affecting an aesthetic appearance of the eyewear 400 to a person looking at the user of the eyewear from the front.

In another embodiment, shown in FIG. 9b, the eyewear 400 includes a cutaway 490 formed in the eyewear frame 410 proximate an upper left corner of the frame. As may be understood by reference to the above-described FIG. 9a, the cutaway 490 is substantially semi-circular (e.g., semi-circular) and formed adjacent an upper outside portion of the lens 422 so that the cutaway is substantially positioned between the sensor 480 and the face of the user when the eyewear 400 is worn by the user. This embodiment should be understood to be substantially similar, e.g. the same, as FIG. 9a, except that, the cutaway 490 is formed in the eyewear frame 410 proximate the opposing corner of the frame. This particular embodiment should be understood to provide an alternate display lens determined by, for example, user style preference, user comfort, or user physical necessity (e.g. vision deficiency in one eye, muscular or neurological damage affecting one side of the body, or skeletal curvatures affecting the user's field of vision. In other embodiments, the eyewear (e.g., eyeglasses, goggles, sunglasses, etc . . . ) may include multiple computing devices and/or multiple cutaways (e.g., one computing device on each temple and a corresponding cutaway for each computing device).

Eyewear Lens with Cutaway

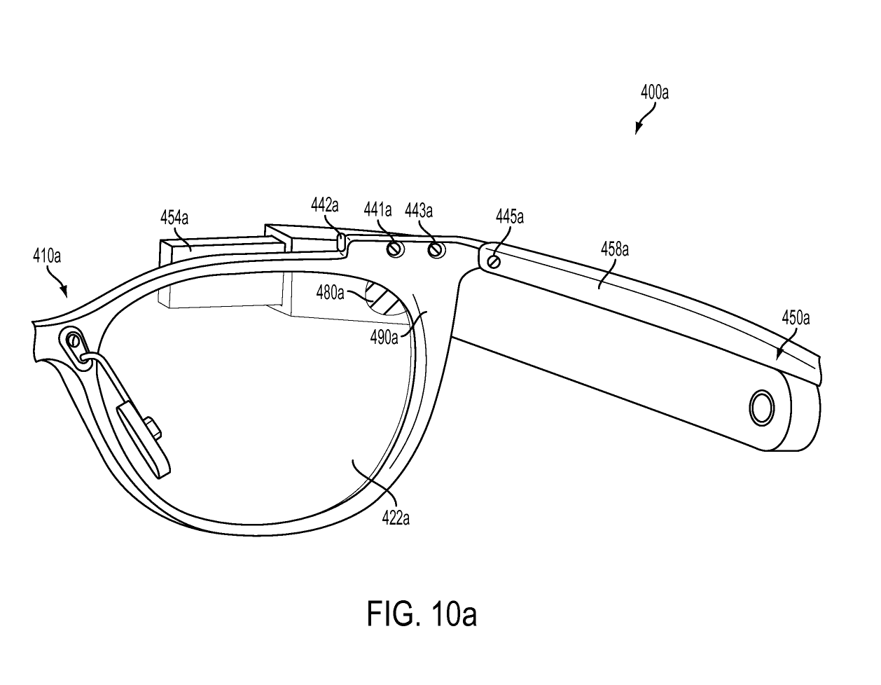

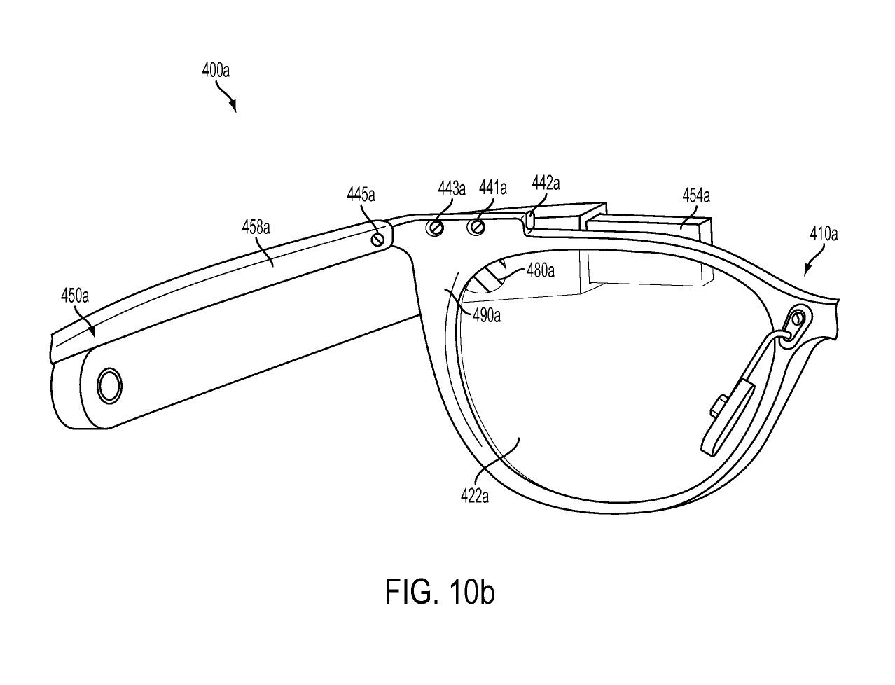

In yet another embodiment as shown in FIGS. 10a and 10b, an eyewear 400a comprises similar components as the eyewear 100 described in FIG. 1, which will not be repeated herein for the purpose of brevity. However, it should be understood from reference to this disclosure that the various parts of the eyewear 400a function similarly to those corresponding parts described with reference to, and shown in, FIG. 1. As such, only particular differences between the eyewear 400 and the eyewear 100 of FIG. 1 will be described in this Section. Eyewear 400a comprises a first and a second screw (or other suitable fastener), respectively, 441a and 443a for selectively coupling the computing device mounting arm 442a to the eyewear frame 410a. The eyewear 400a also comprises a third screw 445a for selectively coupling the computing device mounting portion 458a (FIG. 10a) to the computing device mounting arm 442a (FIG. 10a).

Referring particularly to FIG. 10a, the eyewear 400a may comprise a cutaway 480a defined by a lens 422a of the eyewear proximate an upper right corner of the frame. As may be understood by reference to the figure, the cutaway 480a may be substantially semi-circular (e.g., semi-circular) and defined by an upper outside portion of the lens 422a so that the cutaway 480a is substantially positioned between the computing device's sensor and the face of the user when the eyewear 400a is worn by the user. Referring briefly to FIG. 10a, the cutaway 480a has a dimension (e.g., a width and/or radius) of between about 1 millimeter and about 10 millimeters. In a particular embodiment, this dimension is about 5 millimeters in length. As shown in FIG. 10a, the dimension is the radius, and the cutaway 480a is substantially semi-circular. In other embodiments, the cutaway 480a may be of any other suitable shape (e.g., the cutaway may have a substantially uniform cross-section in the shape of, for example, any suitably sized polygon such as a rectangle or triangle). In particular embodiments, the cutaway 480a is sufficiently large to allow air, heat, and/or radiation to flow (e.g., substantially freely) through the cutaway.

In the embodiment shown in FIG. 10a, the cutaway 480a has a substantially uniform cross-section (e.g., a profile of the cutaway 480a is substantially the same throughout the thickness of the eyewear frame). In other embodiments, the cutaway 480a has a first dimension adjacent a rear face 411a of the eyeglass frame 410a and a second dimension adjacent a front face (not pictured) of the eyeglass frame 410a. For example, the cutaway 480a may be substantially conical so that a substantially circular opening of the cutaway 480a formed on the frame's rear face 411a is at least slightly larger than a substantially circular opening of the cutaway 480a formed on the frame's front face (not pictured). In some embodiments, the substantially conical configuration of the cutaway 480a may assist in at least partially directing airflow from the user's face toward the area in front of the frame 410a (e.g., toward at least a portion of the computing device 450a such as the sensor 480a).

It should be understood that the cutaway 480a may be sized and positioned to enable the computing device's sensor (e.g., IR sensor) to detect the movement of the user's face substantially without the eyeglass frame 410a or lens 422a interfering with heat or other radiation registration of the sensor while the user is wearing the eyewear. The sensor, for example, may be configured to detect movement of the user's face at least in part by sensing differences in the level of radiated heat traveling between the user's face and the sensor. As may be understood from FIG. 7, the position and configuration of the cutaway 480a may enable substantially unimpeded air, heat and/or radiation flow between the user's face and the sensor. In other embodiments, such as embodiments without a cutaway 480a, the lens 422a, eyewear frame 410a, or both may at least partially interfere with an ability of the sensor to detect facial gestures of the user of the eyewear.

In another embodiment, shown in FIG. 10b, the eyewear 400a includes a cutaway 480a formed in the lens 422a proximate an upper left corner of the frame. As may be understood by reference to the above-described FIG. 10b, the cutaway 480a is substantially semi-circular (e.g., semi-circular) and formed adjacent an upper outside portion of the lens 422a so that the cutaway is substantially positioned between the sensor and the face of the user when the eyewear 400a is worn by the user. This embodiment should be understood to be substantially similar, e.g. the same, as FIG. 10a, except that, the cutaway 480a is formed in the lens 422a proximate the opposing corner of the frame. This particular embodiment should be understood to provide an alternate display lens determined by, for example, user style preference, user comfort, or user physical necessity (e.g. vision deficiency in one eye, muscular or neurological damage affecting one side of the body, or skeletal curvatures affecting the user's field of vision. In other embodiments, the eyewear (e.g., eyeglasses, goggles, sunglasses, etc . . . ) may include multiple computing devices and/or multiple cutaways (e.g., one computing device on each temple and a corresponding cutaway for each computing device).

### Exemplary Use

In various embodiments, when the computing device 150 is supported by the computing device support arm 142, the earpiece 132, the nose pads 104 and 106, and computing device ear support portion 171 are configured to cooperate to maintain the eyewear 100 adjacent the user's head. While wearing the eyewear 100, the user may, for example, view content from the computing device 150 by looking through one or more lenses 122, 124 and viewing the display 154. In particular embodiments, by enabling a user to view the display 154 through the one or more lenses, 122, 124, the eyewear may enable the user to view the display 154 substantially clearly (e.g., because the user would be looking at the display through corrective lenses if they require them.).

As noted above, the computing device and sensor(s) may be adapted to sense one or more movements of the user (e.g., the user's face or other portions of the user's body) through an opening in the eyewear. The computing device may, for example, be further adapted to execute one or more functions at least partially in response to sensing such movements. For example, the computing device may be adapted to take a picture, start or stop filming a video, turn on, turn off, or execute any other suitable function in response to a user winking, blinking, raising an eyebrow, etc. The computing device may be further configured to use the sensor(s) to detect when a user has put on or taken off the eyewear and to execute one or more functions in response to such information. For example, the computing device may be adapted to turn the computing device on or off, or place the computing device into sleep mode in response to determining that the user has put on or taken off the eyewear.

### Alternative Embodiments

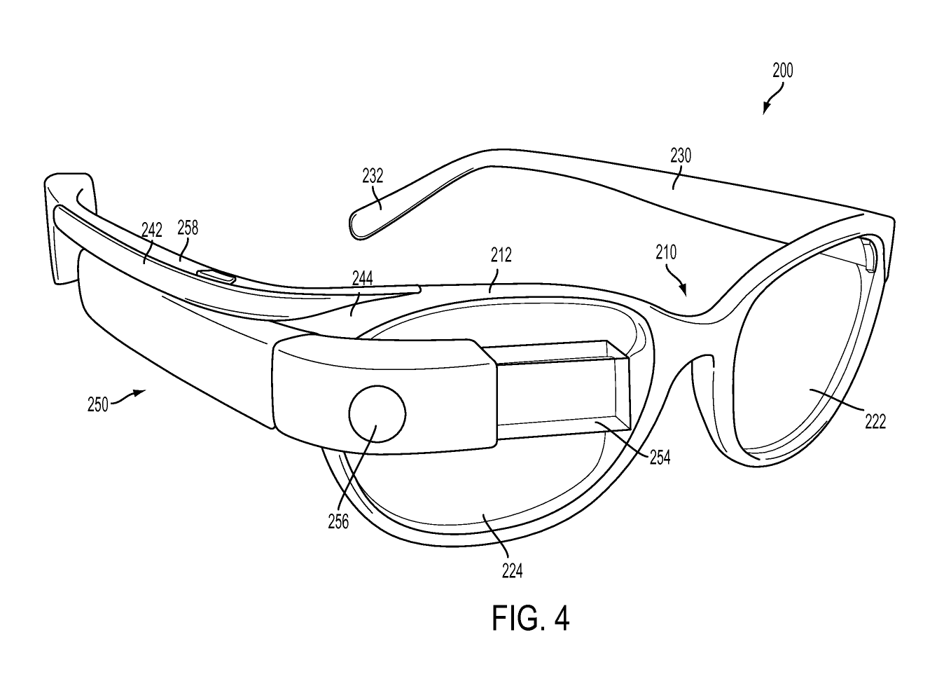

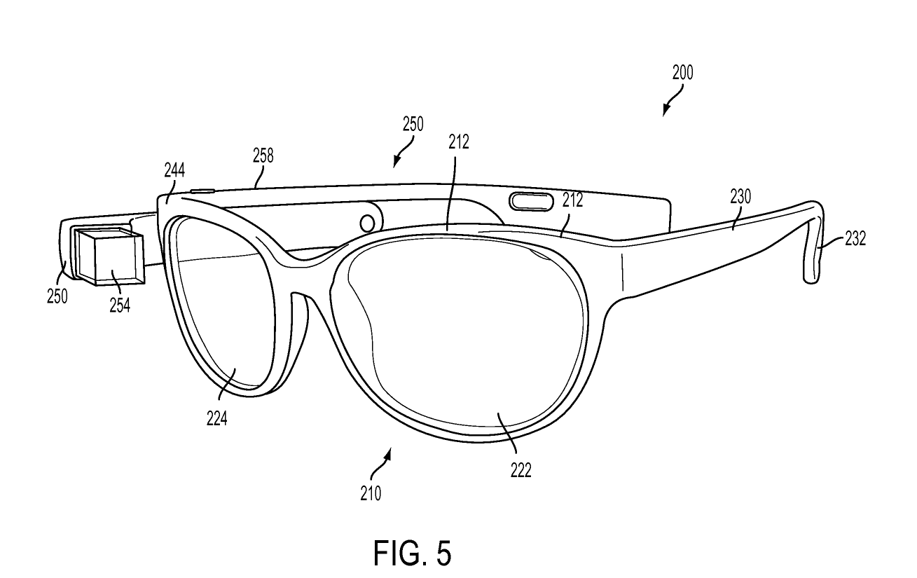

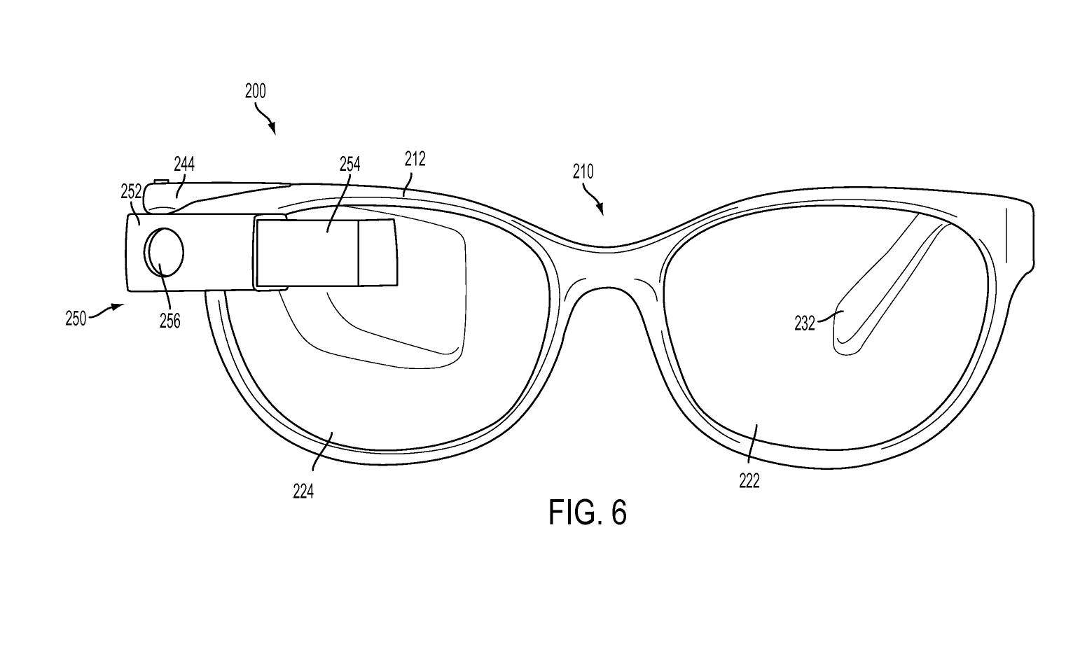

Alternative Frame Design FIGS. 4-6 show a computing device 250 coupled to an eyewear frame 210 having cat-eye shaped lenses 222, 224. The eyewear frame 210 in these figures differs from the eyewear frame 110 shown in the embodiment of FIGS. 1-3 since the top surface 212 of the eyewear frame 210 is curved. In this embodiment, computing device supporting arm mount 244 extends upwardly and outwardly from the curved surface instead of upwardly as shown in the embodiment of FIGS. 1-3. In this configuration, the computing device mounting arm is positioned higher than the first temple portion 230 so as to allow the display 254 to be correctly positioned adjacent the lens 222.

### Computing Device Support Mechanism

In various embodiments, the eyewear 100 may be configured to support the computing device 150 using any other suitable portion of the eyewear 110 (e.g., a portion of the eyewear other than the computing device support arm 142). In particular embodiments, any suitable combination of elements of the eyewear 110 may cooperate to support the computing device (e.g., the display may be integrally formed with the frame 110).

### Voice Control of Computing Device

In various embodiments, the computing device may comprise one or more microphones (not shown) and be configured to receive instructions and commands via a user's voice (e.g., using any suitable voice-recognition techniques).

### Adjustable Nose Pads

In various embodiments, the eyewear may include any suitable mechanism for adjusting a position of the display relative to the eyewear frame, the eyewear user's eyes, etc. For example, in a particular embodiment, the eyewear may include one or more adjustable nose pads (e.g., metal nose pads) that are substantially adjustable (e.g., adjustable) such that the eyewear is configured to enable a user to adjust the nose pads to raise or lower the eyewear frame relative to the user's face (which may, for example, adjust the position of the display relative to the user's eye or eyes, or relative to one or more of the cutaways discussed above).

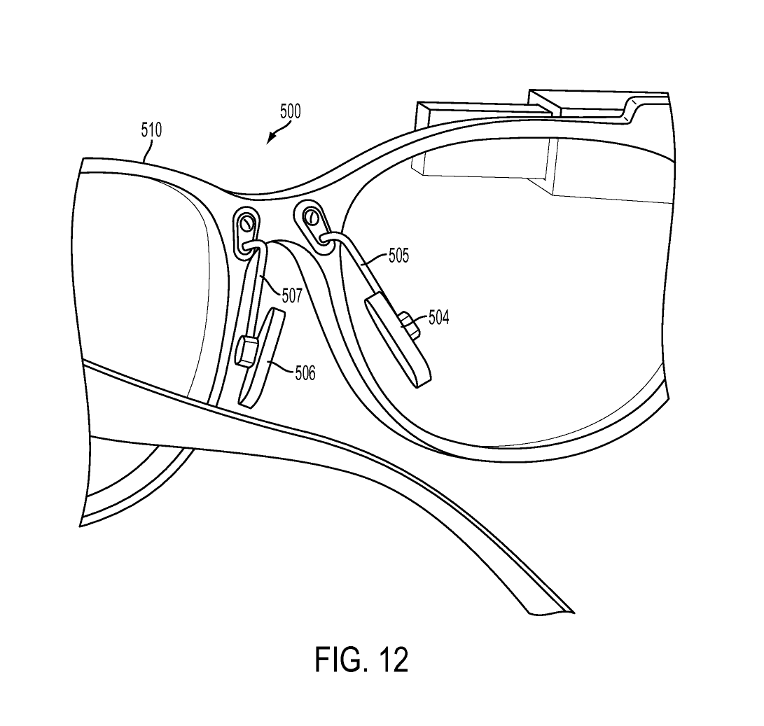

In another embodiment shown in FIG. 12, the eyewear 500 includes adjustable nose pads 504, 506. As shown in this figure, the nose pads 504, 506 comprise adjustable arms 505, 507 that are configured to enable a user (e.g., a user of the eyewear 500) to adjust the position of the nose pads 504, 506 relative to the eyewear frame 510. As may be understood from this figure, the user may adjust the adjustable arms 505, 507 by squeezing the adjustable arms 505, 507 closer together in order to raise the position of the eyewear 500 relative to the user's face when the user is wearing the eyewear 500 (e.g., because the closer position of the nose pads 504, 506 may cause the nose pads 504, 506 to sit higher on the user's nose). In various embodiments, the user may adjust the adjustable arms 505, 507 by spreading the adjustable arms 505, 507 apart from one another in order to lower the position of the eyewear 500 relative to the user's face when the user is wearing the eyewear 500 (e.g., because the further separation of the nose pads 504, 506 may cause the nose pads 504, 506 to sit lower on the user's nose).

In particular embodiments, a user may adjust the adjustable arms 505, 507 in order to more comfortably fit the eyewear 500 based at least in part on a shape of the user's nose (e.g., to accommodate a wider nose, a narrower nose, a bigger nose, a smaller nose, etc.). In various embodiments, adjusting the arm supports 505, 507 may enable the user to position the eyewear 500 while they are wearing the eyewear 500 in such a way that the display is in a position suitable for viewing without substantially interfering with the user's vision (e.g., such as in any of the positions described above).

In various embodiments, the adjustable arms 505, 507 may comprise any material suitable for both allowing a user to manipulate (e.g., adjust) the adjustable arms 505, 507 and maintaining the adjustable arms 505, 507 in a substantially stable position (e.g., in a substantially fixed position) while the user is wearing the eyewear. This material may include, for example, any suitable metal (e.g., a relatively malleable metal such as aluminum, titanium, or alloy, etc.). In a particular embodiment, the adjustable arms 505, 507 may be sufficiently stiff to enable the nose pads 504, 506 to support the eyewear on the user's nose such that the eyewear is in a substantially constant (e.g., fixed) position relative to the user's face. In other embodiments, the adjustable arms 505, 507 may be sufficiently flexible to enable a user to substantially easily adjust the adjustable arms 505, 507 and thus adjust the position of the nose pads 504, 506 relative to the eyewear frame 510.

### Exemplary Computing Device Architecture

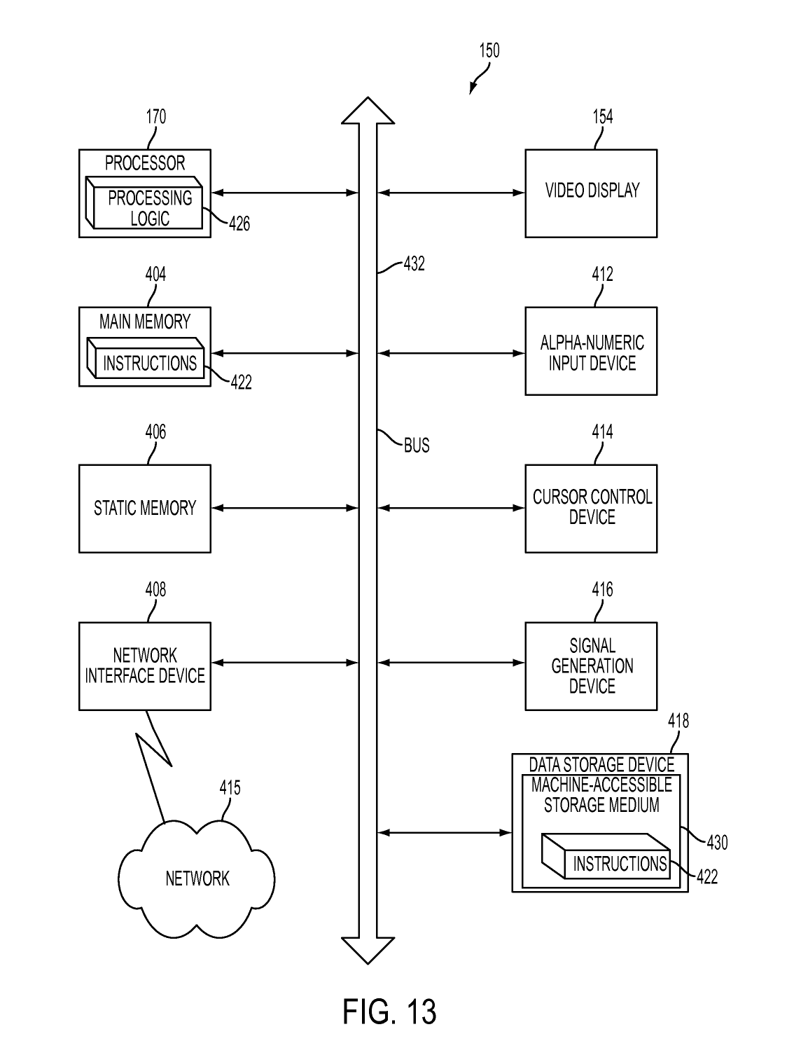

FIG. 13 illustrates a diagrammatic representation of a computing device that can be used within computerized eyewear such as the computerized eyewear discussed above. In particular embodiments, the computing device 150 may be connected (e.g., networked) to other computers in a LAN, an intranet, an extranet, the Internet, wirelessly (e.g., via WIFI), via Bluetooth, etc. As noted above, the computing device 150 may operate in the capacity of a server or a client computer in a client-server network environment, or as a peer computer in a peer-to-peer (or distributed) network environment. Further, while only a single computer is illustrated, the term “computer” shall also be taken to include any collection of computers that individually or jointly execute a set (or multiple sets) of instructions to perform any one or more of the methodologies discussed herein.

An exemplary computing device 150 includes the processing device 170, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 632.

The processing device 170 represents one or more general-purpose processing devices such as a microprocessor, a central processing unit, or the like. More particularly, the processing device 170 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 170 may also be one or more special-purpose processing devices such as an application specific integrated circuit (ASIC), a field programmable gate array (FPGA), a digital signal processor (DSP), network processor, or the like. The processing device 170 may be configured to execute processing logic 626 for performing various operations and steps discussed herein.

The computing device 150 may further include a network interface device 608. The computing device 150 also may include the video display unit 154 (e.g., a liquid crystal display (LCD), a plasma display, a Light Emitting Diode display (LED), a cathode ray tube (CRT), or any other suitable display that can be supported by an eyewear frame), an alphanumeric input device 612 (e.g., a Bluetooth keyboard), a voice-control module (not shown), a cursor control device 614 (e.g., a Bluetooth mouse), and a signal generation device 616 (e.g., a speaker).

The data storage device 618 may include a non-transitory computer-readable storage medium 630 (also known as a non-transitory computer-readable storage medium or a non-transitory computer-readable medium) on which is stored one or more sets of instructions (e.g., software 622) that the processing device 170 may be configured to perform. The software 622 may also reside, completely or at least partially, within the main memory 604 and/or within the processing device 170 during execution thereof by the computing device 150—the main memory 604 and the processing device 170 also constituting computer-readable storage media. The software 622 may further be transmitted or received over a network 615 via a network interface device 608.

While the computer-readable storage medium 630 is shown in an exemplary embodiment to be a single medium, the term “computer-readable storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding or carrying a set of instructions for execution by the computer and that cause the computer to perform any one or more of the methodologies of the present invention. The term “computer-readable storage medium” should accordingly be understood to include, but not be limited to, solid-state memories, optical and magnetic media, etc.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, the eyewear described in this embodiment may include any other suitable eyewear, such as, for example, ski or swim goggles, sunglasses, safety goggles or glasses, etc. Therefore, it is to be understood that the invention is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

what is claimed is:

1. Eyewear comprising:
an eyewear frame having a first side and a second side, said eyewear frame defining:
a top surface;
a front face;
a rear face; and
a first lens support portion that is adapted to support at least one lens, said first lens support portion defining a cutaway that:
extends between said front and rear faces of said frame; and
is adapted to provide a channel between the front and rear faces of said frame when said first lens support portion is supporting a lens;
a first temple portion that extends substantially rearwardly from said eyeglass frame adjacent said first side of said eyewear frame; and
a second temple portion, positioned adjacent said second side of said eyewear frame, that is adapted to selectively extend substantially parallel to said first temple portion, and that is adapted to support a computing device having at least one sensor.

2. The eyewear of claim 1, wherein said at least one sensor comprises an infrared sensor.

3. The eyewear of claim 1, wherein said second temple portion is adapted to support said computing device in a position in which said at least one sensor is disposed substantially in front of and spaced apart from said eyewear frame front face.

4. The eyewear of claim 3, wherein said second temple portion is adapted to support said computing device in a position in which said at least one sensor is disposed substantially in front of and spaced apart from said cutaway.

5. The eyewear of claim 4, wherein said cutaway is formed adjacent a perimeter edge of an upper and outer portion of one of said at least one lens.

6. The eyewear of claim 4, wherein said cutaway is configured so that air may flow substantially freely between said at least one sensor and a face of a user of said eyewear through said cutaway.

7. The eyewear of claim 1, wherein said cutaway is substantially semi-circular.

8. The eyewear of claim 1, wherein said cutaway has a radius of between about 1 mm and 10 mm.

9. The eyewear of claim 1, wherein said cutaway has a radius of about 5 mm.

10. The eyewear of claim 1, wherein said cutaway is sized and oriented such that air may flow substantially directly from a face of a user of the eyewear to the at least one sensor.

11. The eyewear of claim 1, wherein said cutaway is substantially in the shape of a conical section.

12. Eyewear comprising:
a frame for supporting at least one lens, said frame comprising:
a first side;
a second side;
a front face;
a rear face;
at least one lens support portion that is positioned adjacent said first side and that defines at least one opening that extends between said front face and said rear face proximate said first side when said at least one lens support portion is supporting said at least one lens; and
a top surface;
a first temple portion that is mounted to extend substantially rearwardly from said first side of said frame, said first temple portion being adapted to support a computing device; and
a second temple portion that is mounted to at least selectively extend rearwardly from said second side of said frame so that said second temple portion is substantially parallel to said first temple portion, wherein:
said computing device comprises at least one display and at least one sensor; and
said first temple portion is adapted to support said computing device in a particular position in which:
said at least one display is adjacent a front face of said lens when said first temple portion is supporting said computing device, and
said at least one sensor is positioned in front of said frame, spaced apart from and adjacent said opening.

13. The eyewear of claim 12, wherein, said first temple portion is adapted so that, when said computing device is in said particular position, said at least one sensor is co-facing said at least one opening.

14. The eyewear of claim 12, wherein said opening has a cross-section selected from a group consisting of:
substantially polygonal; and
substantially circular.

15. The eyewear of claim 12, wherein said opening has a first dimension adjacent said front face and a second dimension adjacent said rear face.

16. The eyewear of claim 15, wherein said second dimension is greater than said first dimension.

17. The eyewear of claim 12, wherein said opening is sized and configured such that air may pass between a face of a user of said eyewear and said at least one sensor substantially without interference from said eyewear frame.

18. A lens adapted for use in eyewear, said lens comprising:
a lens body portion having a front surface and a rear surface, wherein:
said lens defines a cutaway or opening that extends from said front surface to said rear surface; and
said opening or cutaway is dimensioned so that, when said lens is supported about its perimeter by an eyewear frame, said opening or cutaway provides at least a substantially unobstructed channel between said front surface of said lens and said rear surface of said lens.

19. The lens of claim 18, wherein said opening or cutaway comprises an opening.

20. The lens of claim 18, wherein said opening or cutaway comprises a cutaway.

21. The lens of claim 20, wherein said cutaway is disposed adjacent a perimeter of said lens.
